(19) United States
(12) Patent Application Publication
(10) Pub. No.: US 2026/0366820 A1
(43) Pub. Date: Nov. 19, 2026

(54) HEAT EXCHANGER

(71) Applicant: GM GLOBAL TECHNOLOGY OPERATIONS LLC, Detroit, MI (US)

(72) Inventors: Dale MILLER, Rochester Hills, MI (US); Patrick J. Eding, Fremont, MI (US)

(21) Appl. No.: 19/207,868

(22) Filed: May 14, 2025

(51) Int. Cl. F28D 7/00; B33Y 80/00; F28D 21/00; F28F 3/02

(52) U.S. Cl. CPC F28D 7/0008; F28F 3/027; B33Y 80/00; F28D 2021/008

(57) ABSTRACT

A heat exchanger including: a first fluid inlet, a first fluid outlet, and first fluid channels in fluid communication with the first fluid inlet and the first fluid outlet, all of the first fluid channels extending completely and continuously between the first fluid inlet and the first fluid outlet such that the first fluid channels are devoid of dead-ends; and a second fluid inlet, a second fluid outlet, and second fluid channels in fluid communication with the second fluid inlet and the second fluid outlet, all of the second fluid channels extending completely and continuously between the second fluid inlet and the second fluid outlet such that the second fluid channels are devoid of dead-ends. The heat exchanger is formed by additive manufacturing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to single fluid heat exchangers and heat exchangers configured to transfer thermal energy between two or more fluids.

Heat exchangers transfer thermal energy between two or more fluids without mixing the fluids. Heat exchangers are used in both cooling and heating processes. The fluids may be separated by a solid wall to prevent mixing or they may be in direct contact. Heat exchangers are used in, for example, automotive applications, space heating, refrigeration, air conditioning, power stations, chemical plants, petrochemical plants, petroleum refineries, natural-gas processing, sewage treatment, etc. An example of a heat exchanger is found in an internal combustion engine in which engine coolant flows through radiator coils and air flows past the coils, which cools the coolant and heats the incoming air. Another example is a heat sink, which is a passive heat exchanger that transfers the heat generated by an electronic or a mechanical device to a fluid medium, often air or a liquid coolant. Heat exchangers are also used in electric vehicles for thermal management.

### SUMMARY

The present disclosure provides for, in various features, a heat exchanger including: a first fluid inlet, a first fluid outlet, and first fluid channels in fluid communication with the first fluid inlet and the first fluid outlet, all of the first fluid channels extending completely and continuously between the first fluid inlet and the first fluid outlet such that the first fluid channels are devoid of dead-ends; and a second fluid inlet, a second fluid outlet, and second fluid channels in fluid communication with the second fluid inlet and the second fluid outlet, all of the second fluid channels extending completely and continuously between the second fluid inlet and the second fluid outlet such that the second fluid channels are devoid of dead-ends. The first fluid channels and the second fluid channels are intertwined and configured to transfer thermal energy between a first fluid flowing through the first fluid channels and a second fluid flowing through the second fluid channels without mixing the first fluid and the second fluid. The heat exchanger is formed by additive manufacturing.

In further features, at an outermost periphery of the heat exchanger, sidewalls defining the first fluid channels and the second fluid channels are exterior walls of the heat exchanger.

In further features, at the outermost periphery of the heat exchanger the sidewalls defining the first fluid channels and the second fluid channels have a uniform wall thicknesses.

In further features, the present disclosure provides for: a first inlet manifold adjacent to the first fluid inlet, the second fluid channels at the first inlet manifold are closed by first rounded baffles; a first outlet manifold adjacent to the first fluid outlet, the second fluid channels at the first outlet manifold are closed by second rounded baffles; a second inlet manifold adjacent to the second fluid inlet, the first fluid channels at the second inlet manifold are closed by third rounded baffles; and a second outlet manifold adjacent to the second fluid outlet, the first fluid channels at the second outlet manifold are closed by fourth rounded baffles.

In further features, at least some of both the first fluid channels and the second fluid channels have a triply periodic minimal surface (TPMS) lattice shape in cross-section.

In further features, at least some of both the first fluid channels and the second fluid channels are gyroid-shaped in cross-section.

In further features, the heat exchanger is configured for use with a battery thermal management system of a vehicle.

In further features, the heat exchanger is configured for use with a vehicle heating, ventilation, and air conditioning system.

In further features, the present disclosure includes a housing including a majority of both the first fluid channels and the second fluid channels, a portion of the first fluid channels and the second fluid extend beyond walls of the housing to provide at least one of: an integrated support structure configured to interface between the heat exchanger and a build plate or an adjacent heat exchanger; a heat sink; an aesthetic enhancement; and a protective armor.

The present disclosure also provides for, in various features, a first fluid inlet, a first fluid outlet, and first fluid channels defined by a body of the heat exchanger, all of the first fluid channels extending completely and continuously between the first fluid inlet and the first fluid outlet such that the first fluid channels are devoid of dead-ends; and a second fluid inlet, a second fluid outlet, and second fluid channels defined by the body of the heat exchanger, all of the second fluid channels extending completely and continuously between the second fluid inlet and the second fluid outlet such that the second fluid channels are devoid of dead-ends. The first fluid channels and the second fluid channels are intertwined and configured to transfer thermal energy between a first fluid flowing through the first fluid channels and a second fluid flowing through the second fluid channels without mixing the first fluid and the second fluid. At an outermost periphery of the heat exchanger, sidewalls defining the first fluid channels and the second fluid channels have a uniform wall thickness. The heat exchanger is formed by additive manufacturing.

In further features, the first fluid channels at the outermost periphery of the heat exchanger and the first fluid channels at an interior of the heat exchanger are nearly identical in size, and the second fluid channels at the outermost periphery of the heat exchanger and the second fluid channels at the interior of the heat exchanger are nearly identical in size.

In further features, the present disclosure provides for: a first inlet manifold adjacent to the first fluid inlet, the second fluid channels at the first inlet manifold are closed by first rounded baffles; a first outlet manifold adjacent to the first fluid outlet, the second fluid channels at the first outlet manifold are closed by second rounded baffles; a second inlet manifold adjacent to the second fluid inlet, the first fluid channels at the second inlet manifold are closed by third rounded baffles; and a second outlet manifold adjacent to the second fluid outlet, the first fluid channels at the second outlet manifold are closed by fourth rounded baffles.

In further features, at least some of both the first fluid channels and the second fluid channels have a triply periodic minimal surface (TPMS) lattice shape in cross-section.

In further features, at least some of both the first fluid channels and the second fluid channels are gyroid-shaped in cross-section.

In further features, the heat exchanger is configured for use with a battery thermal management system of a vehicle.

In further features, the heat exchanger is configured for use with a vehicle heating, ventilation, and air conditioning system (HVAC).

The present disclosure also provides for, in various features, a vehicle including: wheels; a body supported by the wheels; and a heat exchanger. The heat exchanger includes: a first fluid inlet, a first fluid outlet, and first fluid channels defined by a body of the heat exchanger, all of the first fluid channels extending completely and continuously between the first fluid inlet and the first fluid outlet such that the first fluid channels are devoid of dead-ends; and a second fluid inlet, a second fluid outlet, and second fluid channels defined by the body of the heat exchanger, all of the second fluid channels extending completely and continuously between the second fluid inlet and the second fluid outlet such that the second fluid channels are devoid of dead-ends. The first fluid channels and the second fluid channels are intertwined and configured to transfer thermal energy between a first fluid flowing through the first fluid channels and a second fluid flowing through the second fluid channels without mixing the first fluid and the second fluid. At an outermost periphery of the heat exchanger, sidewalls defining the first fluid channels and the second fluid channels have a uniform wall thickness. The heat exchanger is formed by additive manufacturing.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of a heat exchanger in accordance with the present disclosure;

FIG. 2 is a cross-sectional view taken along line 2-2 of FIG. 1;

FIG. 3 is a cross-sectional view of a manifold of the heat exchanger of FIG. 1;

FIG. 4 is a cross-sectional view of various fluid channels of the heat exchanger of FIG. 1;

FIG. 5 is a cross-sectional view of an additional heat exchanger in accordance with the present disclosure;

FIG. 6 is a cross-sectional view of another heat exchanger in accordance with the present disclosure;

FIG. 7 illustrates an exemplary vehicle that the heat exchangers of the present disclosure may be configured to be installed in; and

FIG. 8 illustrates an exemplary method in accordance with the present disclosure for forming a heat exchanger.

In the drawings, reference numbers may be reused to identify similar and/or identical elements.

### DETAILED DESCRIPTION

The present disclosure is directed to heat exchangers formed by additive manufacturing. The heat exchangers of the present disclosure may be formed by any suitable additive manufacturing process. Additive manufacturing is often referred to as three-dimensional printing. Exemplary additive manufacturing techniques include, but are not limited to, the following: fused deposition modeling (FDM); stereolithography (SLA); digital light processing (DLP); selective laser sintering (SLS); direct metal laser sintering (DMLS); selective laser melting (SLM); electron beam melting (EBM); metal binder jetting; sand binder jetting; polyjet/multijet modeling (MJM); laser metal deposition (LMD); laminated object manufacturing (LOM); etc.

The heat exchangers of the present disclosure define two or more fluid channels to accommodate different fluids. The fluid channels are intertwined and configured to simultaneously transfer heat between the different fluids. Because all of the channels are intertwined throughout a majority of the heat exchangers, the heat exchangers of the present disclosure are configured to enhance heat exchange between the different fluids and improve the overall efficiency of the heat exchangers. The teachings of the present disclosure are also applicable to single fluid heat transfer applications, such as heat sinks and internal cooling channels. This can be achieved by (1) only creating one fluid channel or (2) having the same fluid pass through both a first channel and a second channel.

Traditionally, heat exchangers have been limited in geometric complexity, such as due to manufacturing constraints. Traditional heat exchangers have also been made of assembled components having joint interfaces with potential leakage points. The heat exchangers of the present disclosure formed by additive manufacturing eliminate joint interfaces, and permit complex geometries to be formed with relatively large surface areas, such as lattice structures of triply periodic minimal surfaces (TPMS).

The present disclosure includes, for example, TPMS based heat exchangers that are devoid of truncated channels at outermost walls of the heat exchanger. Such truncated channels are undesirable because they may produce partial volume channels and close off flow paths. Such small, truncated channels negatively impact fluid flow and make it more difficult to remove unfused powder after (or when) the heat exchanger is formed by powder bed fusion. Issues of powder removal and sub-optimal fluid flow in TPMS based heat exchangers are addressed in the present disclosure by forming TPMS heat exchangers that are void of partial volume channels and dead-end flow paths.

The heat exchangers of the present disclosure are closed outer web TPMS heat exchangers that are without narrow, partial volume channels at wall interfaces, and are without dead end flow paths. The heat exchangers of the present disclosure are thus without truncated channels. The channels of the present disclosure are initially created using strut lattices approximating the shape of TPMS channels, which are free of open beam members. TPMS lattices are used to trim strut lattices to produce final channel geometry. The channels themselves drive the geometry of the wall interface, and optionally, the shape of the walls of the part.

The heat exchangers of the present disclosure are configured for use in any suitable automotive and non-automotive applications. With respect to automotive applications, for example, the heat exchangers may be configured to facilitate thermal management. For example, and with respect to battery thermal management, the heat exchangers of the present disclosure are configured to help maintain a battery pack at optimal temperature. The heat exchangers can cool the battery when it gets too hot, and warm the battery in cold conditions to ensure efficient operation. With respect to cabin heating and cooling, the heat exchangers of the present disclosure may be configured for use with the heating, ventilation, and air conditioning (HVAC) system of any suitable fully electric vehicle (or partially electric vehicle) to manage cabin temperature. The heat exchangers of the present disclosure may be configured to cool vehicle motors and cool vehicle electronics. The heat exchangers may be configured for use with reversible heat pumps, which can act as both a heater and a cooler. The systems are able to transfer excess heat from the battery to the cabin or vice versa, thereby improving efficiency of the system. The heat exchangers of the present disclosure are configured for any other suitable automotive and non-automotive applications as well.

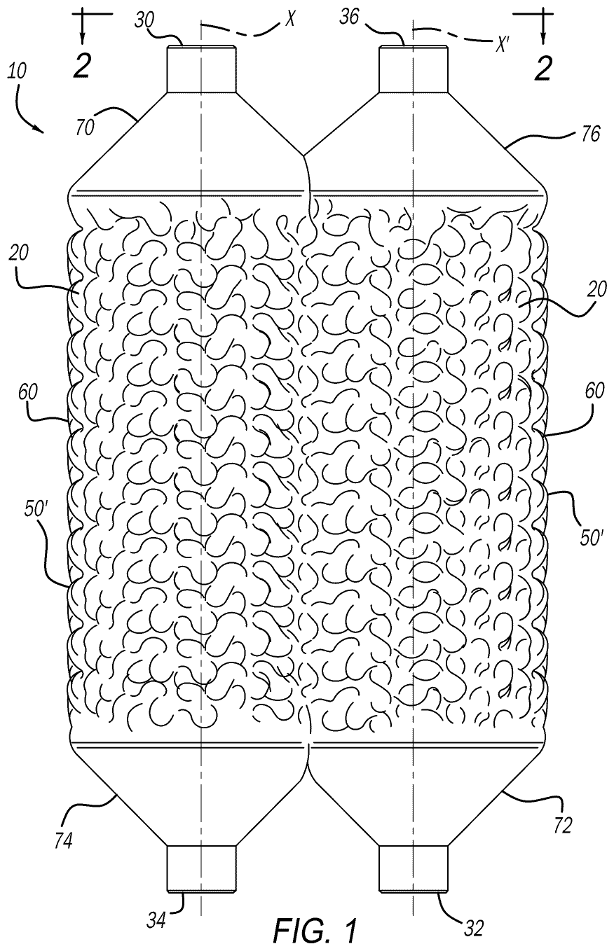

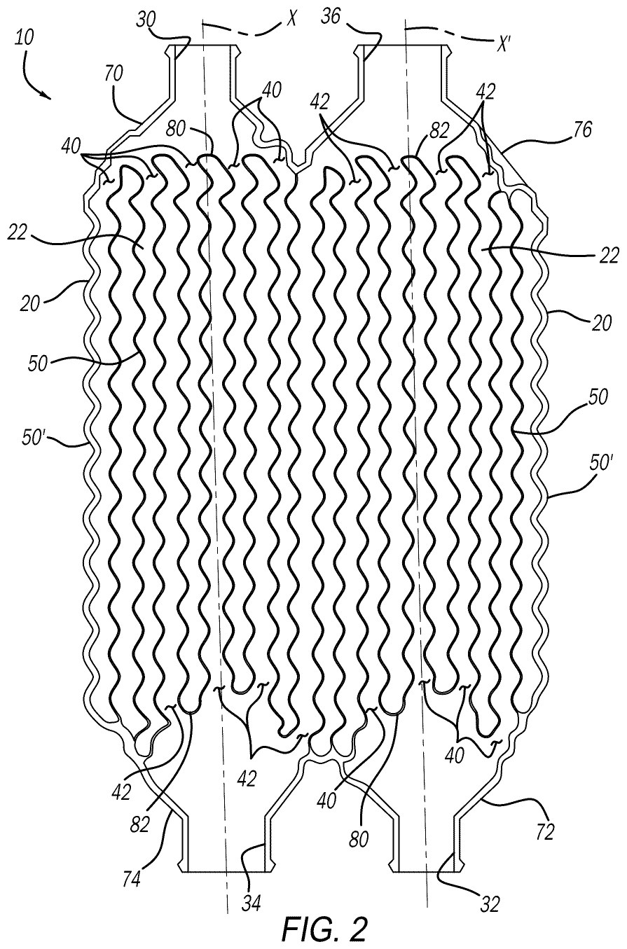

FIGS. 1-3 illustrate a heat exchanger 10 in accordance with the present disclosure. The heat exchanger 10 includes a body 20, which defines a chamber 22 (FIG. 2) therein. The body 20 may have any suitable shape and size, which will depend on the application. In the example illustrated, the body 20 is generally shaped as a pair of adjoined cylinders. Axis X extends through a radial center of one of the cylinders, and axis X′ extends through a radial center of another one of the cylinders in the example illustrated.

The heat exchanger 10 defines various inlets and outlets for fluid. In the example illustrated, the heat exchanger 10 includes a first inlet 30 and a first outlet 32. The heat exchanger 10 also includes a second inlet 34 and a second outlet 36. The body 20 defines first fluid channels 40 and second fluid channels 42. The first fluid channels 40 and the second fluid channels 42 are all generally provided as a lattice structure, which may be formed in any suitable manner, such as by any suitable additive manufacturing process (e.g., 3D-printing).

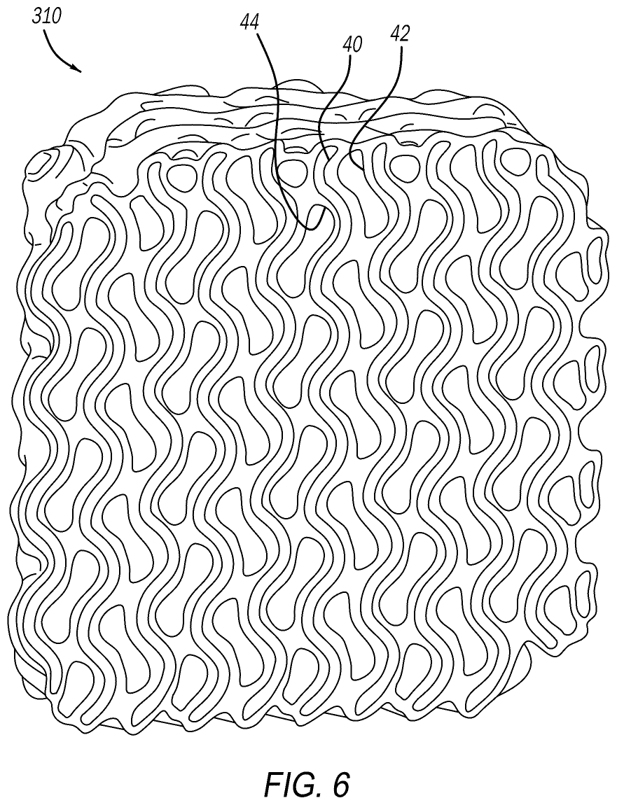

The heat exchanger 10 illustrated in FIGS. 1-5 illustrates only two sets of fluid channels (the first fluid channels 40 and the second fluid channels 42). But the heat exchanger 10 may be configured to include any suitable number of additional fluid channels for accommodating heat exchange between any suitable number of additional fluids. The additional fluid channels will be intertwined with the first fluid channels 40 and the second fluid channels 42. Any suitable number of additional fluid channels may be included, such as 1, 3, 4, 5, 10, 50, 100, etc. FIG. 6 illustrates another heat exchanger 310 of the present disclosure, which is similar to the heat exchanger 10. Unlike the heat exchanger 10, however, the heat exchanger 310 includes third fluid channels 44 in addition to the first fluid channels 40 and the second fluid channels 42. The first fluid channels 40, the second fluid channels 42, and the third fluid channels 44 are all intertwined to permit transfer of thermal energy between the first fluid channels 40, the second fluid channels 42, and the third fluid channels 44.

The first fluid channels 40 are in fluid communication with the first inlet 30 and the first outlet 32. The first fluid channels 40 are not in fluid communication with the second inlet 34 or the second outlet 36. From the first inlet 30, a first fluid will flow through the first fluid channels 40 and exit the heat exchanger 10 through the first outlet 32. The second fluid channels 42 are not in fluid communication with the first inlet 30 or the first outlet 32.

The second fluid channels 42 are in fluid communication with the second inlet 34 and the second outlet 36. The second fluid channels 42 are not in fluid communication with the first inlet 30 or the first outlet 32. From the second inlet 34, a second fluid will flow through the second fluid channels 42 and exit the heat exchanger 10 through the second outlet 36. The first fluid channels 40 are not in fluid communication with the second inlet 34 or the second outlet 36.

The first fluid channels 40 and the second fluid channels 42 are intertwined with each other. Walls 50 of the body 20 define the first fluid channels 40 and the second fluid channels 42, and separate the first fluid channels 40 from the second fluid channels 42. The walls 50 are configured to permit transfer of thermal energy between the first fluid flowing through the first fluid channels 40 and the second fluid flowing through the second fluid channels 42 without mixing the first fluid and the second fluid.

The walls 50 include outermost walls 50′, which define outer sidewalls 60 of the body 20. The outermost walls 50′ partially define the first fluid channels 40 at an outermost periphery of the body 20. The outermost walls 50′ also partially define the second fluid channels 42 at an outermost periphery of the body 20. All of the first fluid channels 40 at the outermost periphery of the body 20, which are at least partially defined by the outermost walls 50′, are identical in size (or nearly identical in size without drastic fluid channel size reduction due to truncation at the lattice periphery) with the first fluid channels 40 at an interior of the body 20 that are defined entirely by the walls 50. The heat exchanger 10 is thus devoid of any truncated channels at the outer sidewalls 60, which may reduce fluid flow and make removal of unfused interior powder difficult after additive manufacturing.

The heat exchanger 10 further includes a first inlet manifold 70 adjacent to the first inlet 30. A first outlet manifold 72 is adjacent to the first outlet 32. A second inlet manifold 74 is adjacent to the second inlet 34. And a second outlet manifold 76 is adjacent to the second outlet 36.

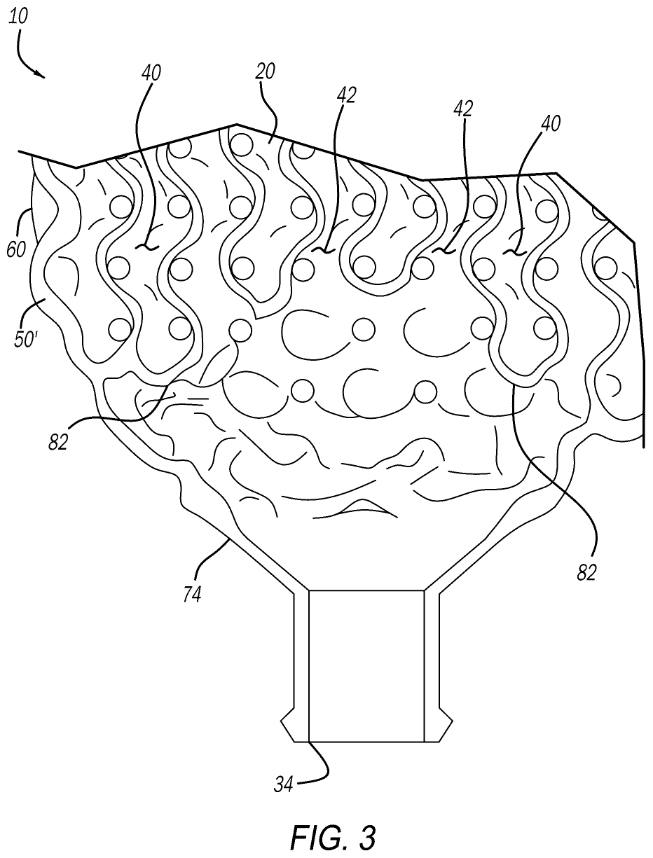

With particular reference to FIG. 2 and FIG. 3, at the first inlet manifold 70 and at the first outlet manifold 72, the second fluid channels 42 are closed by second rounded baffles 80. At the second inlet manifold 74 and at the second outlet manifold 76, the first fluid channels 40 are closed by first rounded baffles 82. The first rounded baffles 82 and the second rounded baffles 80 improve fluid flow, reduce pressure drop, and enhance overall performance of the heat exchanger 10.

All of the first fluid channels 40 (which includes the first fluid channels 40 at the outermost walls 50′ and the first fluid channels 40 at interior baffles (walls)) extend completely and continuously between the first inlet 30 and the first outlet 32 such that the first fluid channels 40 are devoid of dead-ends. Likewise, all of the second fluid channels 42 (which includes the second fluid channels 42 at the outermost walls 50′ and the second fluid channels 42 at interior baffles (walls)) extend completely and continuously between the second inlet 34 and the second outlet 36 such that the second fluid channels 42 are devoid of dead-ends.

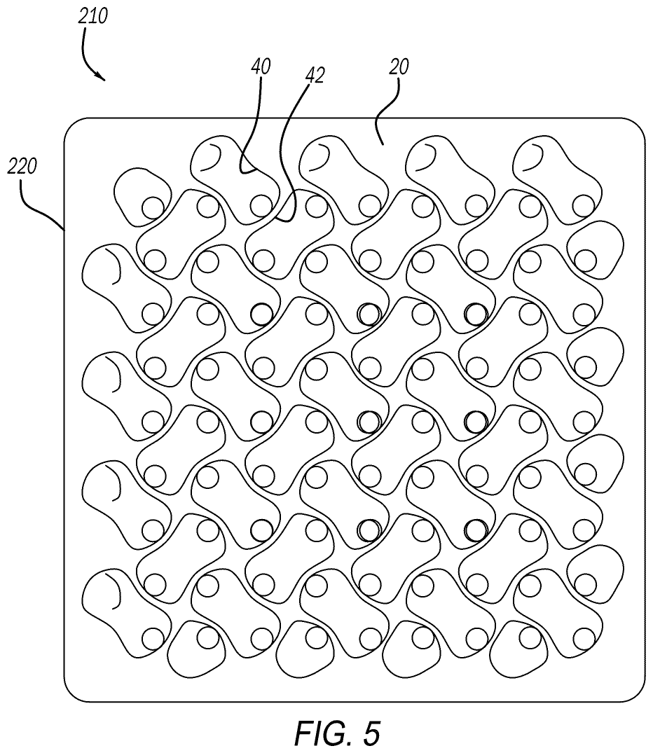

As illustrated in FIGS. 1 and 2, for example, the outermost walls 50′ and the walls 50 at an interior of the body 20 all have a uniform thickness. The outermost walls 50′ are corrugated walls that conform to a closed outer web of the first fluid channels 40 and the second fluid channels 42. As a result, less material is required to form the heat exchanger 10 as compared to, for example, a heat exchanger 210 as illustrated in FIG. 5. The heat exchanger 10 thus has less mass than the heat exchanger 210. The heat exchanger 210 of FIG. 5 is similar to the heat exchanger 10 except that the outermost walls 220 have not been trimmed to confirm to the first fluid channels 40 and the second fluid channels 42 thereof.

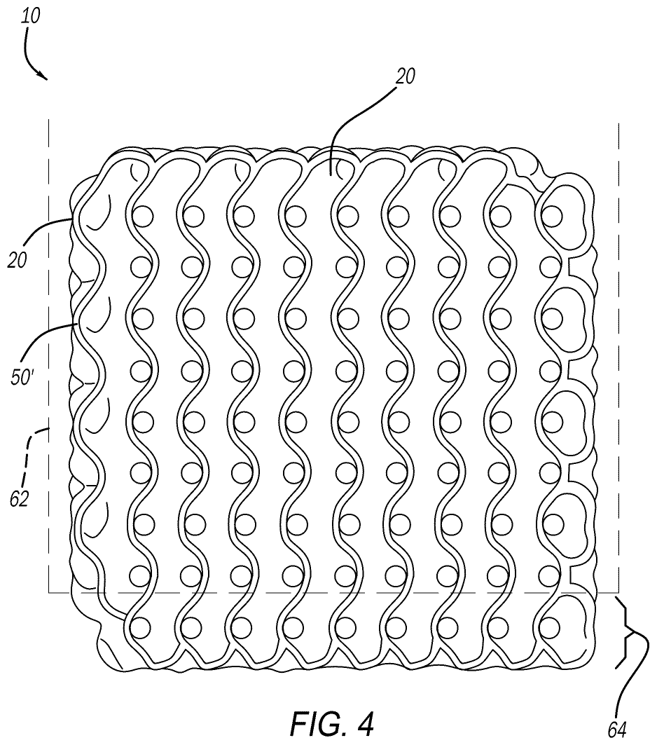

With renewed reference to FIG. 4, the heat exchanger 10 may include a housing 62 outboard of the outermost walls 50′. At a bottom of the housing 62, portions of the first fluid channels 40 and the second fluid channels 42 may extend out from within the housing 62 to form a base 64. The base 64 may be configured as (1) an integrated support structure configured to interface between the heat exchanger 10 and a build plate or an adjacent heat exchanger, (2) a heat sink, (3) an aesthetic enhancement, and/or (4) a protective armor. As illustrated in FIGS. 4 and 5, the first fluid channels 40 and the second fluid channels 42 may be gyroid-shaped in cross-section. As least a portion of the gyroid-shape may include a planar surface to facilitate forming of the first fluid channels 40 and/or the second fluid channels 42 by additive manufacturing.

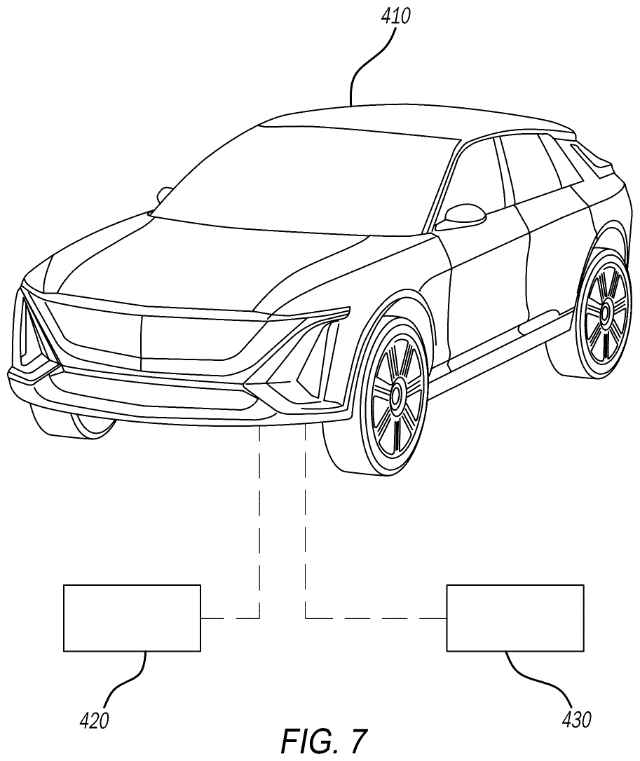

FIG. 7 illustrates an exemplary vehicle 410, which the heat exchangers of the present disclosure, such as the heat exchangers 10, 210, 310, may be configured for installation in. For example, the vehicle 410 may include a battery thermal management system 420. The heat exchangers 10, 210, 310 may be included with the battery thermal management system 420 to facilitate heating and cooling of battery modules. The vehicle 410 may further include a heating, ventilation, and air conditioning (HVAC) system 430. The heat exchangers 10, 210, 310 may be included with the HVAC system 430 to facilitate transfer of thermal energy between two different fluids, such as refrigerant and air, to heat or cool air circulated through a passenger cabin of the vehicle.

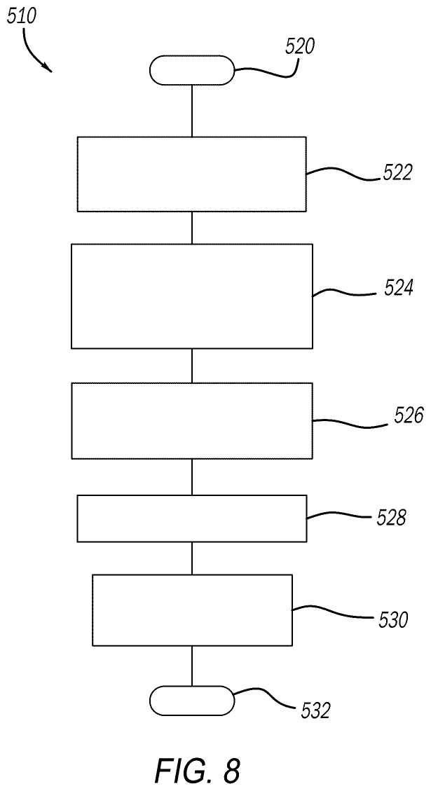

FIG. 8 illustrates an example of a method 510 in accordance with the present disclosure for forming the heat exchanger 10, 210, 310 of the present disclosure, or any other suitable heat exchanger. In the example described below, the method 510 is described in the context of forming the heat exchanger 10. The method 510 may also be used to form the heat exchangers 210, 310, or any other suitable heat exchangers.

The method 510 starts at block 520, at which a user accesses any suitable control module configured to run any suitable computer design program. At block 522, the user maps end points and lines for strut lattice unit cells of the first fluid channels 40, and maps end points and lines for strut lattice unit cells of the second fluid channels 42. The strut lattices are representations of standard TPMS channel paths that have been reconstructed in strut lattice form. The points and lines must be calculatedly located to align with the channel centerlines of the selected TPMS structure. Every TPMS structure (gyroid, diamond, Schwarz, etc.) will have its own unique pair of struct lattices.

At block 522, using any suitable design software and any suitable user interface, the user maps end points coincident to theoretical centerlines of the first fluid channels 40. The user operates the design software to connect the points with lines following the channel path of the first fluid channels 40, and forms a thickened unit cell based on the mapped points. The second fluid channels 42 (and any suitable additional fluid channels) are mapped in a similar manner.

From block 522, the method 510 proceeds to block 524. At block 524, the user and/or the design software patterns the unit cell for the first fluid channels 40 over a domain of the heat exchanger where the first fluid channels 40 are to be provided. The unit cell is patterned with open beam members removed to create a strut lattice of the first fluid channels 40. In a similar manner, strut lattice unit cells of the second fluid channels 42 are mapped over a domain of the heat exchanger where the second fluid channels 42 are to be provided.

From block 524, the method 510 proceeds to block 526. At block 526, the user operates the design software to delete open beam members at boundaries of the strut lattice formed for the first fluid channels 40 and at boundaries of the strut lattice formed for the second fluid channels 42. The removal of open beam members ensures that there are no dead-end flow paths along the first fluid channels 40 and the second fluid channels 42. Thus, all of the first fluid channels 40 will extend completely and continuously between the first inlet 30 and the first outlet 32. And all of the second fluid channels 42 will extend completely and continuously between the second inlet 34 and the second outlet 36.

From block 526, the method 510 proceeds to block 528. At block 528, the user operates the design software to trim the strut lattice channels of the first fluid channels 40 and the second fluid channels 42 with a TPMS lattice to provide a uniform distance between the channels. For example, the strut lattice channels of the first fluid channels 40 are trimmed using a traditional walled TPMS gyroid structure to create the final channel geometry of the first fluid channels 40. The strut lattice channels of the second fluid channels 42 are also trimmed using the same walled TPMS gyroid structure to create the final channel geometry of the second fluid channels. The thick strut lattice must be trimmed with precise TPMS structure that the strut lattice is mimicking (i.e., trimming cannot be performed with any arbitrary TPMS structure, rather, it must be a match for the strut lattice). Assembling two (or more) distinct TPMS based fluid channels in accordance with the method 510 advantageously results in the absence of partial and/or dead-end flow paths. Trimming the strut lattices with a walled or standard TPMS structure achieves uniform distance between the first fluid channels 40 and the second fluid channels 42, thereby providing a uniform thickness of the walls 50.

The method 510 may further include forming and thickening the outermost walls 50′ of the heat exchanger 10 to follow a corrugated path conforming to the closed outer web of the first fluid channels 40 and the second fluid channels 42. Furthermore, the walls 50 and/or the outermost walls 50′ may be formed such that surfaces thereof are planar or pointed rather than smooth. At block 530, the heat exchanger configured by the user using the design software is formed using any suitable additive manufacturing technique. Suitable additive manufacturing techniques include, but are not limited to, the following: fused deposition modeling (FDM); stereolithography (SLA); digital light processing (DLP); selective laser sintering (SLS); direct metal laser sintering (DMLS); selective laser melting (SLM); electron beam melting (EBM); metal binder jetting; sand binder jetting; polyjet/multijet modeling (MJM); laser metal deposition (LMD); laminated object manufacturing (LOM); etc. The method 510 ends at block 532.

The present disclosure provides for heat exchangers, such as the heat exchangers 10, 210, 320 with enhanced fluid flow and performance. The present disclosure provides for heat exchangers and methods of forming heat exchangers that improve the ability to remove powder from TPMS based heat exchangers produced using powder bed fusion technology, thus reducing processing times and enhancing cost efficiencies. Corrugated baffle walls at the walls 50 and the outermost walls 50′ enhance fluid flow and reduce pressure drop, and improve overall heat exchanger performance as compared to parts with traditional, smooth, non-conformal baffle walls. Configuring the outermost walls 50′ as corrugated and conformal reduces material usage and part mass as compared to heat exchangers with smooth, non-conformal walls of variable wall thickness. Unlike walls of traditional TPMS heat exchangers produced using powder bed fusion, corrugated walls and baffles are self-supporting in all orientations, including parallel to the build plate, thus enhancing design freedom.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A heat exchanger comprising:
a first fluid inlet, a first fluid outlet, and first fluid channels in fluid communication with the first fluid inlet and the first fluid outlet, all of the first fluid channels extending completely and continuously between the first fluid inlet and the first fluid outlet such that the first fluid channels are devoid of dead-ends; and
a second fluid inlet, a second fluid outlet, and second fluid channels in fluid communication with the second fluid inlet and the second fluid outlet, all of the second fluid channels extending completely and continuously between the second fluid inlet and the second fluid outlet such that the second fluid channels are devoid of dead-ends,
wherein:
the first fluid channels and the second fluid channels are intertwined and configured to transfer thermal energy between a first fluid flowing through the first fluid channels and a second fluid flowing through the second fluid channels without mixing the first fluid and the second fluid, and
the heat exchanger is formed by additive manufacturing.

2. The heat exchanger of claim 1, wherein at an outermost periphery of the heat exchanger, sidewalls defining the first fluid channels and the second fluid channels are exterior walls of the heat exchanger.

3. The heat exchanger of claim 2, wherein at the outermost periphery of the heat exchanger the sidewalls defining the first fluid channels and the second fluid channels have a uniform wall thicknesses.

4. The heat exchanger of claim 1, further comprising:
a first inlet manifold adjacent to the first fluid inlet, the second fluid channels at the first inlet manifold are closed by first rounded baffles;
a first outlet manifold adjacent to the first fluid outlet, the second fluid channels at the first outlet manifold are closed by second rounded baffles;
a second inlet manifold adjacent to the second fluid inlet, the first fluid channels at the second inlet manifold are closed by third rounded baffles; and
a second outlet manifold adjacent to the second fluid outlet, the first fluid channels at the second outlet manifold are closed by fourth rounded baffles.

5. The heat exchanger of claim 1, wherein at least some of both the first fluid channels and the second fluid channels have a triply periodic minimal surface (TPMS) lattice shape in cross-section.

6. The heat exchanger of claim 1, wherein at least some of both the first fluid channels and the second fluid channels are gyroid-shaped in cross-section.

7. The heat exchanger of claim 1, wherein the heat exchanger is configured for use with a battery thermal management system of a vehicle.

8. The heat exchanger of claim 1, wherein the heat exchanger is configured for use with a vehicle heating, ventilation, and air conditioning system.

9. The heat exchanger of claim 1, further comprising a housing including a majority of both the first fluid channels and the second fluid channels, a portion of the first fluid channels and the second fluid extend beyond walls of the housing to provide at least one of: an integrated support structure configured to interface between the heat exchanger and a build plate or an adjacent heat exchanger; a heat sink; an aesthetic enhancement; and a protective armor.

10. A heat exchanger comprising:
a first fluid inlet, a first fluid outlet, and first fluid channels defined by a body of the heat exchanger, all of the first fluid channels extending completely and continuously between the first fluid inlet and the first fluid outlet such that the first fluid channels are devoid of dead-ends; and
a second fluid inlet, a second fluid outlet, and second fluid channels defined by the body of the heat exchanger, all of the second fluid channels extending completely and continuously between the second fluid inlet and the second fluid outlet such that the second fluid channels are devoid of dead-ends,
wherein:
the first fluid channels and the second fluid channels are intertwined and configured to transfer thermal energy between a first fluid flowing through the first fluid channels and a second fluid flowing through the second fluid channels without mixing the first fluid and the second fluid,
at an outermost periphery of the heat exchanger, sidewalls defining the first fluid channels and the second fluid channels have a uniform wall thickness, and
the heat exchanger is formed by additive manufacturing.

11. The heat exchanger of claim 10, wherein:
the first fluid channels at the outermost periphery of the heat exchanger and the first fluid channels at an interior of the heat exchanger are nearly identical in size, and
the second fluid channels at the outermost periphery of the heat exchanger and the second fluid channels at the interior of the heat exchanger are nearly identical in size.

12. The heat exchanger of claim 10, further comprising:
a first inlet manifold adjacent to the first fluid inlet, the second fluid channels at the first inlet manifold are closed by first rounded baffles;
a first outlet manifold adjacent to the first fluid outlet, the second fluid channels at the first outlet manifold are closed by second rounded baffles;
a second inlet manifold adjacent to the second fluid inlet, the first fluid channels at the second inlet manifold are closed by third rounded baffles; and
a second outlet manifold adjacent to the second fluid outlet, the first fluid channels at the second outlet manifold are closed by fourth rounded baffles.

13. The heat exchanger of claim 10, wherein at least some of both the first fluid channels and the second fluid channels have a triply periodic minimal surface (TPMS) lattice shape in cross-section.

14. The heat exchanger of claim 10, wherein at least some of both the first fluid channels and the second fluid channels are gyroid-shaped in cross-section.

15. The heat exchanger of claim 10, wherein the heat exchanger is configured for use with a battery thermal management system of a vehicle.

16. The heat exchanger of claim 10, wherein the heat exchanger is configured for use with a vehicle heating, ventilation, and air conditioning system (HVAC).

17. A vehicle comprising:
wheels;
a body supported by the wheels; and
a heat exchanger comprising:
a first fluid inlet, a first fluid outlet, and first fluid channels defined by a body of the heat exchanger, all of the first fluid channels extending completely and continuously between the first fluid inlet and the first fluid outlet such that the first fluid channels are devoid of dead-ends; and
a second fluid inlet, a second fluid outlet, and second fluid channels defined by the body of the heat exchanger, all of the second fluid channels extending completely and continuously between the second fluid inlet and the second fluid outlet such that the second fluid channels are devoid of dead-ends,
wherein:
the first fluid channels and the second fluid channels are intertwined and configured to transfer thermal energy between a first fluid flowing through the first fluid channels and a second fluid flowing through the second fluid channels without mixing the first fluid and the second fluid,
at an outermost periphery of the heat exchanger, sidewalls defining the first fluid channels and the second fluid channels have a uniform wall thickness, and
the heat exchanger is formed by additive manufacturing.

18. The vehicle of claim 17, further comprising a battery thermal management system including the heat exchanger.

19. The vehicle of claim 17, further comprising a heating, ventilation, and air conditioning system (HVAC) including the heat exchanger.

20. The vehicle of claim 17, further comprising:
a first inlet manifold adjacent to the first fluid inlet, the second fluid channels at the first inlet manifold are closed by first rounded baffles;
a first outlet manifold adjacent to the first fluid outlet, the second fluid channels at the first outlet manifold are closed by second rounded baffles;
a second inlet manifold adjacent to the second fluid inlet, the first fluid channels at the second inlet manifold are closed by third rounded baffles; and
a second outlet manifold adjacent to the second fluid outlet, the first fluid channels at the second outlet manifold are closed by fourth rounded baffles.
